(19) United States
(12) Patent Application Publication
(10) Pub. No.: US 2014/0043566 A1
(43) Pub. Date: Feb. 13, 2014

(54) DISPLAY DEVICE WITH INCREASED OPTICAL EFFICIENCY

(71) Applicant: SAMSUNG DISPLAY CO., LTD., YONGIN-CITY (KR)

(72) Inventors: KWANG KEUN LEE, OSAN-SI (KR); HYUN MIN CHO, HWASEONG-SI (KR); JAEWOONG KANG, JEONJU-SI (KR); JAE BYUNG PARK, SEOUL (KR); HAE IL PARK, SEOUL (KR)

(73) Assignee: SAMSUNG DISPLAY CO., LTD., YONGIN-CITY (KR)

(21) Appl. No.: 13/829,306

(22) Filed: Mar. 14, 2013

(30) Foreign Application Priority Data
Aug. 9, 2012 (KR) 10-2012-0087390

(51) Int. Cl. G02F 1/1335

(52) U.S. Cl. CPC G02F 1/133617
USPC 349/71

(57) ABSTRACT

A liquid crystal display according to an exemplary embodiment of the present invention includes a first substrate. A color conversion layer is disposed on the first substrate. A second substrate and a third substrate are disposed on the color conversion layer and face each other. A light amount controlling layer is disposed between the second substrate and the third substrate. A backlight unit is disposed under the first substrate.

### CROSS-REFERENCE TO RELATED APPLICATION

This application claims priority to and the benefit of Korean Patent Application No. 10-2012-0087390 filed in the Korean Intellectual Property Office on Aug. 9, 2012, the entire contents of which are incorporated herein by reference.

### TECHNICAL FIELD

The present invention relates to a display device, and more particularly, the present invention relates to a display device with increased optical efficiency.

### DISCUSSION OF THE RELATED ART

Computer monitors, television sets, mobile phones, and the like are all examples of products that utilize display devices. Suitable display devices may be cathode ray tube display devices, liquid crystal display devices, organic light emitting diode display devices, and plasma display devices.

The liquid crystal display, which is one of the most common types of flat panel displays currently in use, includes two display panels with field generating electrodes, such as a pixel electrode and a common electrode, incorporated thereon, and a liquid crystal layer interposed therebetween. The liquid crystal display generates an electric field in the liquid crystal layer by applying a voltage to the field generating electrodes and determines the direction of liquid crystal molecules of the liquid crystal layer by the generated electric field, thus controlling polarization of incident light so as to display an image.

In a general display device, both a light amount controlling layer which determines luminance by controlling a light amount passing through a substrate and a color forming layer which determines an emitting light color are formed. For example, the light amount controlling layer uses a polarizer and a liquid crystal layer and the color forming layer uses a color filter. However, while the light emitted from a backlight is passed through the color filter, brightness thereof is decreased. Accordingly, light efficiency is decreased by the color filter formed in the liquid crystal display.

Recently, instead of the color filter, a display device using a phosphor or quantum dots has been developed. However, display devices converting color by using phosphors or quantum dots use ultraviolet (UV) light or near UV light as a light source, and in a case of light having a short wavelength, a polarization characteristic of a conventional polarizer is low such that it is difficult to use the liquid crystal layer as the light amount controlling layer.

### SUMMARY OF THE INVENTION

The present invention provides a display device capable of using a conventional polarizer and a liquid crystal layer as a light amount controlling layer while increasing efficiency of light by using a phosphor as a color conversion layer instead of a color filter.

A liquid crystal display according to an exemplary embodiment of the present invention includes a first substrate. A color conversion layer is disposed on the first substrate. A second substrate and a third substrate are disposed on the color conversion layer and face each other. A light amount controlling layer is disposed between the second substrate and the third substrate. A backlight unit is disposed under the first substrate.

The color conversion layer may include a partition disposed on the first substrate, and a plurality of phosphors disposed in a region defined by the partition.

A first polarizer disposed between the second substrate and the color conversion layer may be further included.

A second polarizer disposed outside the third substrate may be further included. Polarization axes of the first polarizer and the second polarizer may cross each other.

The backlight unit may emit ultraviolet light, near ultraviolet light, or blue light.

A light blocking member formed between the second substrate and the color conversion layer may be further included.

An assistance layer formed between the second substrate and the color conversion layer and including a light transmitting part and a light shielding part may be further included.

The liquid crystal display according to an exemplary embodiment of the present invention includes the color conversion layer disposed between the liquid crystal panel and the backlight. The color conversion layer is made of a resin including the phosphor. Accordingly, ultraviolet light or near ultraviolet light emitted from the backlight pass through the color conversion layer and is converted into visible light displaying the desired color. The visible light is incident to the liquid crystal panel. The light amount may be accordingly controlled using the liquid crystal panel including the conventional polarizer and the liquid crystal layer, thereby displaying the image having the desired color and brightness. Accordingly, the desired color may be displayed without the color filter inside the liquid crystal panel, the light efficiency may be increased, and the liquid crystal panel including the conventional polarizer and the liquid crystal layer may be used as the light amount controlling layer even though the color conversion layer including the phosphor is used.

A display device includes a backlight unit, a color conversion layer, and a first substrate disposed between the backlight unit and the color conversion layer. A second substrate and a third substrate are disposed on the color conversion layer. A light amount controlling layer is disposed between the second substrate and the third substrate.

A display device includes a backlight unit. A color conversion layer converts light from the backlight unit into colored light. A first substrate is disposed between the backlight unit and the color conversion layer. The first substrate is disposed below the color conversion layer and above the backlight unit. A second substrate and a third substrate are disposed above the color conversion layer and receive the colored light from the color conversion layer. A light amount controlling layer is disposed between the second substrate and the third substrate.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a schematic cross-sectional view of a display device according to an exemplary embodiment of the present invention;

FIG. 2 is a graph showing a polarization characteristic of a polarizer according to a wavelength of light according to an exemplary embodiment of the present invention;

FIG. 3 is a schematic cross-sectional view of a display device according to an exemplary embodiment of the present invention;

FIG. 4 is an enlarged view of a portion A of FIG. 3;

FIG. 5 is a schematic cross-sectional view of a display device according to an exemplary embodiment of the present invention; and

FIG. 6 is an enlarged view of a portion B of FIG. 5.

### DETAILED DESCRIPTION OF THE EMBODIMENTS

Exemplary embodiments of the present invention will be described more fully hereinafter with reference to the accompanying drawings. As those skilled in the art would realize, the described embodiments may be modified in various different ways, all without departing from the spirit or scope of the present disclosure.

In the drawings, the thickness of layers, films, panels, regions, etc., may be exaggerated for clarity. Like reference numerals may designate like elements throughout the specification. It will be understood that when an element such as a layer, film, region, or substrate is referred to as being “on” another element, it can be directly on the other element or intervening elements may also be present.

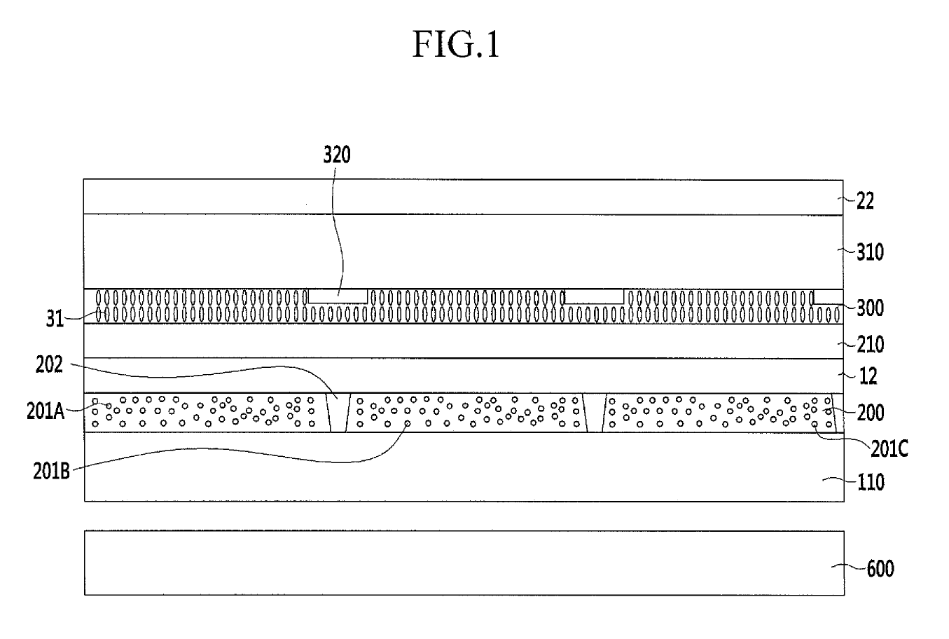

A display device according to an exemplary embodiment of the present invention will be described with reference to FIG. 1. FIG. 1 is a schematic cross-sectional view of a display device according to an exemplary embodiment of the present invention.

Referring to FIG. 1, a display device according to an exemplary embodiment of the present invention includes a first substrate 110, a second substrate 210, and a third substrate 310 that are sequentially disposed.

The first substrate 110, the second substrate 210, and the third substrate 310 may be made of transparent glass or plastic.

A color conversion layer 200 is disposed between the first substrate 110 and the second substrate 210, and a light amount controlling layer 300 is disposed between the second substrate 210 and the third substrate 310.

A backlight unit 600 is disposed outside the first substrate 110.

The first substrate 110, the second substrate 210, the third substrate 310, the color conversion layer 200, and the light amount controlling layer 300 include a plurality of pixels corresponding in a vertical direction. The plurality of pixels may be disposed in a matrix shape on a plane surface.

A first polarizer 12 and a second polarizer 22 are attached at surfaces opposite to surfaces where the first substrate 100 and the second substrate 200 face each other. For example, the first polarizer 12 may be attached outside the first substrate 100, and the second polarizer 22 may be attached outside the second substrate 200. A transmissive axis of the first polarizer 12 and a transmissive axis of the second polarizer 22 may be crossed with respect to each other.

The light amount controlling layer 300 may include a plurality of liquid crystal molecules 31.

Although not shown, a gate line, a data line, a switching element connected to the gate line and the data line, and a pixel electrode connected to the switching element may be formed on the second substrate 210. A switching element and a pixel electrode may be formed for each pixel. Also, a common electrode facing the pixel electrode may be formed on the third substrate 310. A vertical electric field is formed between the pixel electrode and the common electrode, thereby determining the direction of the liquid crystal molecules 31.

A first light blocking member 320 dividing a boundary of a plurality of pixels is formed on the second substrate 210 and/or the third substrate 310.

A shape and position of each electrode formed on the second substrate 210 and the third substrate 310 may be variously changed. The pixel electrode may be formed on the second substrate 210 and the common electrode may be formed on the third substrate 310, however the present invention is limited thereto. The pixel electrode and the common electrode may be both formed on the second substrate 2100, and in this case, a horizontal electric field is formed between the pixel electrode and the common electrode thereby determining the direction of alignment of the liquid crystal molecules 31.

The color conversion layer 200 includes a plurality of partitions 202 dividing a plurality of pixel areas. A plurality of phosphors 201A, 201B, and 201C is disposed in a plurality of pixel areas deified by the partitions. A plurality of pixels of the color conversion layer 200 may include first color pixels, second color pixels, and third color pixels. For example, the first color pixels may be red pixels, the second color pixels may be green pixels, and the third color pixels may be blue pixels. Light passing through the red pixels of the color conversion layer 200 represents red, light passing through the green pixels represents green, and light passing through the blue pixels represents blue.

The color conversion layer 200 may include a resin including the phosphors 201A, 201B, and 201C. The phosphors may include a material that fluoresces light having a unique color upon exposure to light regardless of a color of the light that the phosphor is exposed to. Further, light is emitted from each phosphor over all regions regardless of a direction of the light that the phosphor is exposed to.

The color conversion layer 200 of the first pixel includes the first phosphor 201A, the color conversion layer 200 of the second pixel includes the second phosphor 201B, and the color conversion layer 200 of the third pixel includes the third phosphor 201C.

If light is incident to the first phosphor 201A from the backlight unit 600, light of the first color is scattered. If light is incident to the second phosphor 201B, light of the second color is scattered. If light is incident to the third phosphor 201C, light of the third color is scattered. The first color may be red, the second color may be green, and the third color may be blue, and in this case, the first phosphor 201A may be a red phosphor, the second phosphor 201B may be a green phosphor, and the third phosphor 201C may be a blue phosphor. However, the first phosphor 201A, the second phosphor 201B, and the third phosphor 201C of the display device according to an exemplary embodiment of the present invention may scatter light of other colors besides red, green, and blue. Although not shown, the color conversion layer 200 may include an additional phosphor and the phosphor may scatter light of a fourth color.

The backlight unit 600 supplying light to color conversion layer 200 may provide ultraviolet light, near ultraviolet light, or blue light.

In this way, the display device according to an exemplary embodiment of the present invention includes a liquid crystal panel including the second substrate 210 and the third substrate 310. A liquid crystal layer 300 is disposed between the second substrate 210 and the third substrate 310. The liquid crystal layer 300 includes a plurality of liquid crystal molecules 31. The first polarizer 12 and the second polarizer 22 are disposed outside the second substrate 210 and the third substrate 310, respectively. The backlight unit 600 is disposed outside the second substrate 210 of the liquid crystal panel. The color conversion unit is disposed between the liquid crystal panel and the backlight unit 600.

The color conversion unit includes the color conversion layer 200 disposed on the first substrate 110. The color conversion layer 200 includes the plurality of partitions 202 and the plurality of phosphors 201A, 201B, and 201C disposed in a region defined by the partitions 202.

The liquid crystal panel includes the plurality of first light blocking members 320 disposed on the second substrate 210 and disposed between the plurality of pixel areas. According to a display device of an exemplary embodiment of the present invention, the first light blocking member 320 may be omitted.

As described above, ultraviolet light, near ultraviolet light, or blue light is emitted from the backlight unit 600. Light emitted from the backlight unit 600 is supplied to the color conversion unit, and light supplied to the color conversion unit passes through the plurality of phosphors 201A, 201B, and 201C inside the color conversion layer 200 such that light displaying the first color, the second color, and the third color is scattered and is supplied to the liquid crystal panel. For example, the ultraviolet light, near ultraviolet light, or blue light emitted from the backlight unit 600 passes through the color conversion unit, and is then converted into a visible light region displaying the first color, the second color, and the third color, and is supplied to the liquid crystal panel.

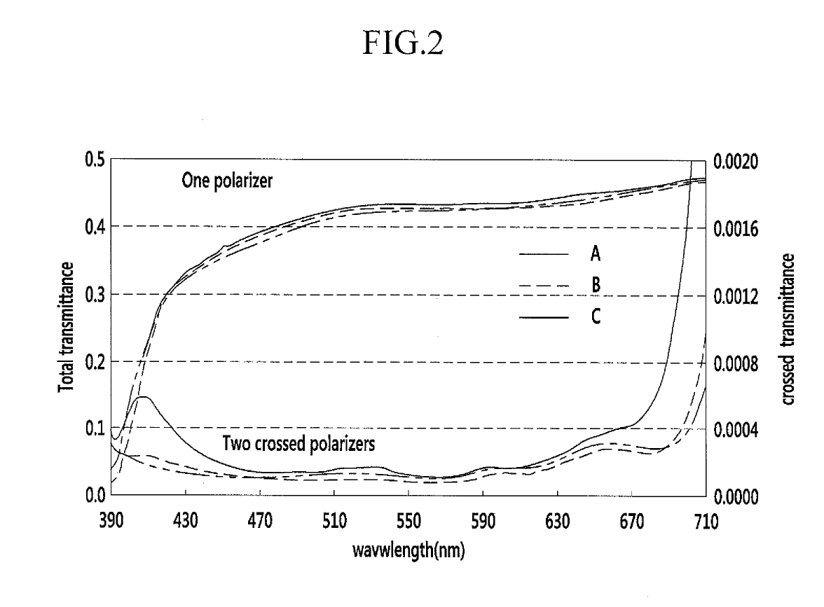

FIG. 2 is a view illustrating a characteristic of a display device according to an exemplary embodiment of the present invention. FIG. 2 includes a graph showing a polarization characteristic of three conventional polarizers according to a wavelength of light.

Referring to FIG. 2, for three conventional polarizers A, B, and C, for light of a wavelength of less than or equal to about 400 nm, an intensity of light passing through one polarizer is very small, and a difference is extremely slight between light passing through one polarizer and light passing through two crossed polarizers. For example, when the backlight unit 600 generates ultraviolet light, near ultraviolet light, or blue light, and when using the conventional polarizer, the polarization characteristic is very low such that it is difficult to use the liquid crystal layer as the light amount controlling layer.

However, the display device according to an exemplary embodiment of the present invention includes the color conversion layer 200 disposed between the liquid crystal panel and the backlight unit 600 to convert ultraviolet light, near ultraviolet light, and blue light in the color conversion layer 200 into visible light, thereby supplying it to the liquid crystal panel with light.

Accordingly, the color filter is not formed in the liquid crystal panel such that deterioration of the intensity of light according to the color filter may be prevented, and the liquid crystal panel including the conventional polarizer may be used as the light amount controlling layer while using the ultraviolet light, near ultraviolet light, or blue light as a light source.

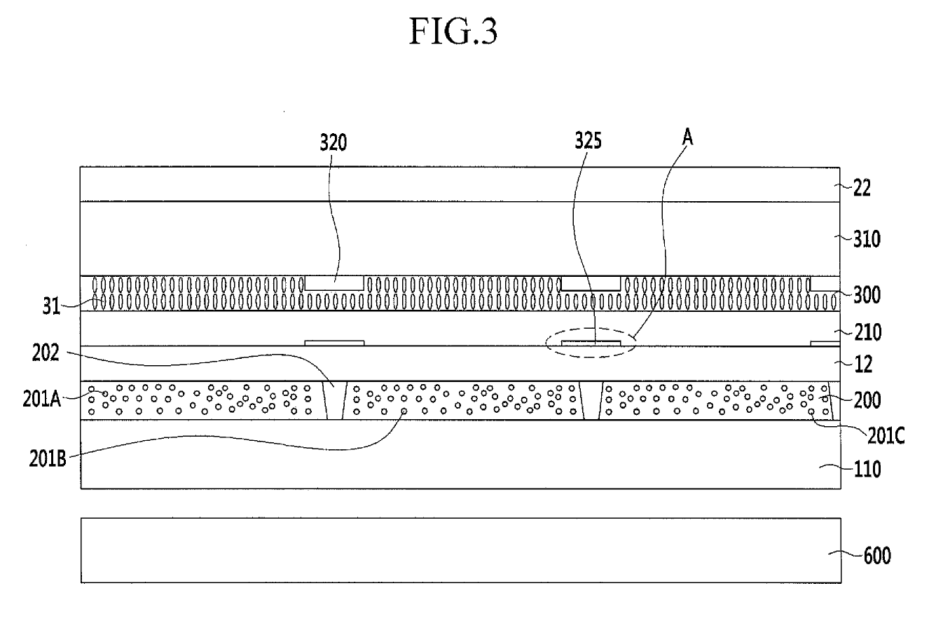

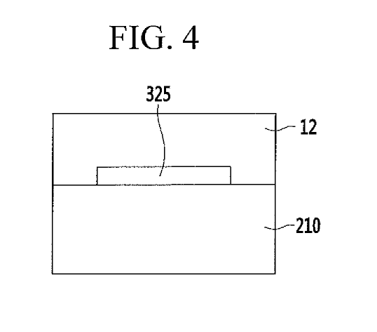

Next, a display device according to an exemplary embodiment of the present invention will be described with reference to FIG. 3. FIG. 3 is a schematic cross-sectional view of a display device according to an exemplary embodiment of the present invention, and FIG. 4 is an enlarged view of a portion A of FIG. 3.

Referring to FIG. 3, the display device according to an exemplary embodiment is similar to the display device discussed above with reference to FIG. 1.

The display device according to an exemplary embodiment of the present invention includes a liquid crystal panel including the second substrate 210 and the third substrate 310. A liquid crystal layer 300 is disposed between the second substrate 210 and the third substrate 310. The liquid crystal layer 300 includes a plurality of liquid crystal molecules 31. The first polarizer 12 and the second polarizer 22 are disposed outside the second substrate 210 and the third substrate 310, respectively. A backlight unit 600 is disposed outside the second substrate 20 of the liquid crystal panel. A color conversion unit is disposed between the liquid crystal panel and the backlight unit 600. The color conversion unit includes the first substrate 110 and a color conversion layer 200 disposed on the first substrate 110. The color conversion layer 200 includes a plurality of partitions 202 and a plurality of phosphors 201A, 201B, and 201C disposed in the region defined by the partitions 202. The liquid crystal panel includes a plurality of first light blocking members 320 disposed on the second substrate 210 and disposed between a plurality of pixel areas.

The display device also includes a second light blocking member 325 disposed outside the second substrate 210 of the liquid crystal panel. The second light blocking member 325 overlaps the first light blocking member 320.

Referring to FIG. 4, the second light blocking member 325 is disposed between the second substrate 210 of the liquid crystal panel and the first polarizer 12. The second light blocking member 325 may be formed on an outer surface of the second substrate 210.

As described above, ultraviolet light, near ultraviolet light, or blue light is emitted from the backlight unit 600. Light emitted from the backlight unit 600 is supplied to the color conversion unit. Light light supplied to the color conversion unit passes through the plurality of phosphors 201A, 201B, and 201C in the color conversion layer 200. Light of the first color, the second color, and the third color is scattered and is supplied to the liquid crystal panel. At this time, the second light blocking member 325 may prevent light scattered in the phosphors 201A, 201B, and 201C from reaching to neighboring pixels.

The characteristics of the display device described above with reference to FIG. 1 may be applied to the display device discussed above with reference to FIG. 3.

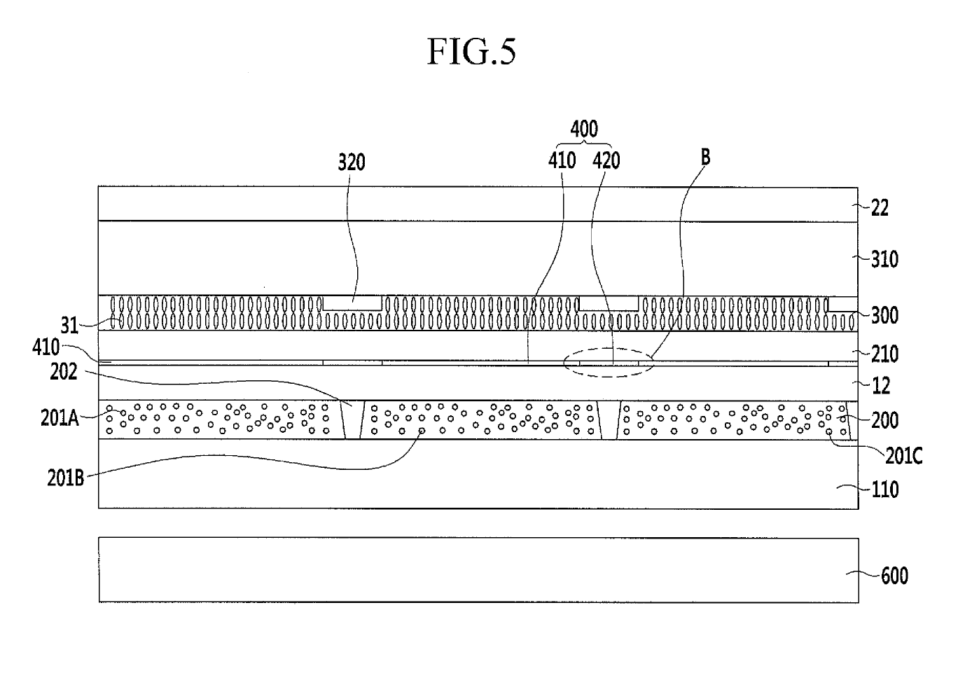

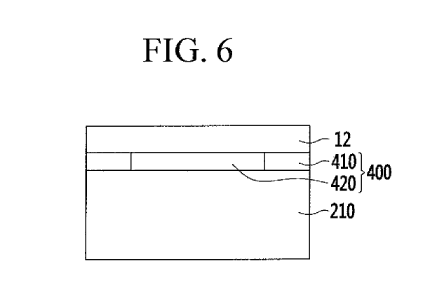

Next, a display device according to an exemplary embodiment of the present invention will be described with reference to FIG. 5 and FIG. 6. FIG. 5 is a schematic cross-sectional view of a display device according to an exemplary embodiment of the present invention, and FIG. 6 is an enlarged view of a portion of FIG. 5.

Referring to FIG. 5, the display device according to an exemplary embodiment is similar to the display device described above with reference to FIG. 1.

The display device includes a liquid crystal panel including the second substrate 210 and the third substrate 310. A liquid crystal layer 300 is disposed between the second substrate 210 and the third substrate 310. The liquid crystal layer 300 includes a plurality of liquid crystal molecules 31. The first polarizer 12 and the second polarizer 22 are disposed outside the second substrate 210 and the third substrate 310, respectively. A backlight unit 600 is disposed outside the second substrate 20 of the liquid crystal panel. A color conversion unit is disposed between the liquid crystal panel and the backlight unit 600 and includes the first substrate 110 and a color conversion layer 200 disposed on the first substrate 110. The color conversion layer 200 includes a plurality of partitions 202 and a plurality of phosphors 201A, 201B, and 201C disposed in the region defined by the partition 202. Also, the liquid crystal panel includes a plurality of first light blocking members 320 disposed on the second substrate 210 and disposed between a plurality of pixel areas.

The display device further includes an assistance layer 400 disposed outside the second substrate 210 of the liquid crystal panel and including a light transmitting part 410 and a light shielding part 420. The light shielding part 420 of the assistance layer 400 is disposed at a position overlapping the first light blocking member 320.

Referring to FIG. 6, the assistance layer 400 is disposed between the second substrate 210 and the first polarizer 12 of the liquid crystal panel. For example, the assistance layer 400 may be formed on the outer surface of the second substrate 220.

As described above, the ultraviolet light, near ultraviolet light, or blue light is emitted by the backlight unit 600. Light emitted from the backlight unit 600 is supplied to the color conversion unit. Light supplied to the color conversion unit passes through a plurality of phosphors 201A, 201B, and 201C in the color conversion layer 200, and the light displaying the first color, the second color, and the third color is scattered and supplied to the liquid crystal panel. At this time, the light shielding part 420 of the assistance layer 400 may prevent light scattered in the phosphors 201A, 201B, and 201C from reaching neighboring pixels. The light transmitting part 410 and the light shielding part 420 may have the same thickness, and thereby the light transmitting part 410 having the same thickness as the light shielding part 420 is disposed in the region outside the region where the light shielding part 420 is disposed. Accordingly, a step change of the polarizer 12 according to the step difference may be prevented.

The characteristics of the display device discussed above with respect to FIG. 1, FIG. 3, and FIG. 4 may be applied to the display device discussed above with respect to FIG. 5.

While exemplary embodiments of the present invention have been described, it is to be understood that the invention is not limited to the disclosed embodiments.

What is claimed is:

1. A display device comprising:
a backlight unit;
a color conversion layer;
a first substrate disposed between the backlight unit and the color conversion layer;
a second substrate and a third substrate disposed on the color conversion layer; and
a light amount controlling layer disposed between the second substrate and the third substrate.

2. The display device of claim 1, wherein
the color conversion layer includes:
a partition disposed on the first substrate; and
a plurality of phosphors disposed in a region defined by the partition.

3. The display device of claim 2, further comprising
a first polarizer disposed between the second substrate and the color conversion layer.

4. The display device of claim 3, further comprising
a second polarizer disposed outside the third substrate,
wherein polarization axes of the first polarizer and the second polarizer cross each other.

5. The display device of claim 2, wherein
the backlight unit emits ultraviolet light, near ultraviolet light, or blue light.

6. The display device of claim 2, wherein
the light amount controlling layer includes a plurality of liquid crystal molecules.

7. The display device of claim 1, further comprising
a first polarizer disposed between the second substrate and the color conversion layer.

8. The display device of claim 7, further comprising
a second polarizer disposed outside the third substrate,
wherein polarization axes of the first polarizer and the second polarizer cross each other.

9. The display device of claim 1, wherein
the backlight unit emits ultraviolet light, near ultraviolet light, or blue light.

10. The display device of claim 1, wherein:
the light amount controlling layer includes a plurality of liquid crystal molecules.

11. The display device of claim 1, further comprising
a light blocking member formed between the second substrate and the color conversion layer.

12. The display device of claim 11, wherein
the color conversion layer includes
a partition disposed on the first substrate, and
a plurality of phosphors disposed in a region defined by the partition.

13. The display device of claim 12, further comprising
a first polarizer disposed between the second substrate and the color conversion layer.

14. The display device of claim 13, further comprising
a second polarizer disposed outside the third substrate,
wherein polarization axes of the first polarizer and the second polarizer cross each other.

15. The display device of claim 12, wherein
the backlight unit emits ultraviolet light, near ultraviolet light, or blue light.

16. The display device of claim 12, wherein
the light amount controlling layer includes a plurality of liquid crystal molecules.

17. The display device of claim 11, further comprising
a first polarizer disposed between the second substrate and the color conversion layer.

18. The display device of claim 17, further comprising
a second polarizer disposed outside the third substrate,
wherein polarization axes of the first polarizer and the second polarizer cross each other.

19. The display device of claim 11, wherein
the backlight unit emits ultraviolet light, near ultraviolet light, or blue light.

20. The display device of claim 11, wherein
the light amount controlling layer includes a plurality of liquid crystal molecules.

21. The display device of claim 1, further comprising
an assistance layer formed between the second substrate and the color conversion layer and including a light transmitting part and a light shielding part.

22. The display device of claim 21, wherein
the color conversion layer includes:
a partition disposed on the first substrate; and
a plurality of phosphors disposed in a region defined by the partition.

23. The display device of claim 22, further comprising
a first polarizer disposed between the second substrate and the color conversion layer.

24. The display device of claim 23, further comprising
a second polarizer disposed outside the third substrate,
wherein polarization axes of the first polarizer and the second polarizer cross each other.

25. The display device of claim 22, wherein
the backlight unit emits ultraviolet light, near ultraviolet light, or blue light.

26. The display device of claim 22, wherein
the light amount controlling layer includes a plurality of liquid crystal molecules.

27. The display device of claim 21, further comprising
a first polarizer disposed between the second substrate and the color conversion layer.

28. The display device of claim 27, further comprising
a second polarizer disposed outside the third substrate,
wherein polarization axes of the first polarizer and the second polarizer cross each other.

29. The display device of claim 21, wherein
the backlight unit emits ultraviolet light, near ultraviolet light, or blue light.

30. The display device of claim 21, wherein
the light amount controlling layer includes a plurality of liquid crystal molecules.
